(19) United States
(12) Patent Application Publication
(10) Pub. No.: US 2024/0131915 A1
(43) Pub. Date: Apr. 25, 2024

(54) Motor Vehicle Comprising a Coupling Mechanism and Coupling Mechanism for a Motor Vehicle

(71) Applicant: Bayerische Motoren Werke Aktiengesellschaft, Muenchen (DE)

(72) Inventor: Klaus ZELGER, Taufkirchen (DE)

(21) Appl. No.: 18/278,454

(22) PCT Filed: Mar. 22, 2022
(86) PCT No.: PCT/EP2022/057565

§ 371 Date: Aug. 22, 2023

(30) Foreign Application Priority Data
Apr. 12, 2021 (DE) 10 2021 109 199.3

(51) Int. Cl. B60K 6/445; B60K 17/16

(52) U.S. Cl. CPC B60K 6/445; B60K 17/16; B60K 2001/001

(57) ABSTRACT

A motor vehicle has at least one electric drive machine for driving the motor vehicle and at least one coupling mechanism which can be switched at least between a coupling position in which the electric drive machine is coupled to a drive wheel of the motor vehicle so as to transmit torque, and a decoupling position in which the electric drive machine is decoupled from the drive wheel. The at least one coupling mechanism is provided for being coupled to exactly one side of a drive axle of the motor vehicle so as to transmit torque and includes a form-fit coupling for switching between the coupling position and the decoupling position.

### BACKGROUND AND SUMMARY

The invention relates to a motor vehicle having at least one electric drive machine for driving the motor vehicle and having at least one coupling mechanism which can be switched at least between a coupling position, in which the electric drive machine is coupled in a torque-transmitting manner to a drive wheel of the motor vehicle, and a decoupling position, in which the electric drive machine is decoupled from the drive wheel. Other aspects of the invention relate to a coupling mechanism for such a motor vehicle and a method for operating a motor vehicle.

With reference to such coupling mechanisms, it is, for example, possible to interrupt a torque transmission between the electric drive machine and drive wheels of a motor vehicle as required (decoupling position) and consequently, for example, to enable a so-called coasting of the motor vehicle during its travel operation and to produce the torque transmission (coupling position) in order to enable a driving of the drive wheels by means of the drive machine,

DE 199 23 316 A1 describes, for example, a drive system for a motor vehicle having a starter and generator unit which is arranged in a drive train with a drive shaft. The starter and generator unit has an electric machine which can be operated as an electric motor with a starter function or an electrical generator and a planetary gear.

An object of the present invention is to provide a motor vehicle having a coupling mechanism which can be operated with little complexity, a corresponding coupling mechanism for such a motor vehicle, and a method for operating such a motor vehicle.

This object is achieved with a coupling mechanism, a motor vehicle having such a coupling mechanism, and a method, in accordance with the independent claims. Advantageous embodiments with advantageous developments of the invention are set out in the dependent claims.

A first aspect of the invention relates to a motor vehicle having at least one electric drive machine for driving the motor vehicle and having at least one coupling mechanism which can be switched at least between a coupling position, in which the electric drive machine is coupled in a torque-transmitting manner to a drive wheel of the motor vehicle, and a decoupling position, in which the electric drive machine is decoupled from the drive wheel. The coupling mechanism may preferably be able to be switched in an automated manner between the coupling position and the decoupling position. The motor vehicle may, for example, comprise a control device by which, for example, a switching apparatus of the coupling mechanism may be able to be controlled. When the switching apparatus is controlled, it can switch as required into the coupling position or the decoupling position and thereby couple or decouple the drive machine with respect to the drive wheel. The term “drive wheel” is in this instance intended to be understood to be a drive element which has direct contact with a contact surface of the motor vehicle and accordingly has at least one rim and a tire which is connected thereto.

According to the invention, there is provision for the at least one coupling mechanism to be provided for torque-transmitting coupling to precisely one side of a drive axle of the motor vehicle and to comprise a positive-locking coupling for switching between the coupling position and the decoupling position. This is advantageous since, as a result of the torque-transmitting coupling to the precisely one side of the drive axle of the motor vehicle, a particularly targeted, so to speak wheel-selective transmission of torque to the drive wheel is enabled.

The expression, according to which the at least one coupling mechanism is provided for torque-transmitting coupling to precisely one side of a drive axle of the motor vehicle, is intended in this instance to be understood to mean that the at least one coupling mechanism is constructed and provided for the single-wheel drive of the drive wheel. In this instance, it is clear that any twin-tires of the drive wheel may also be included thereby.

The positive-locking coupling is intended to be understood to be a coupling in which in the coupling position a transmission of torque is carried out by positive-locking (form-fit) mutual engagement, that is to say, by means of a positive-locking connection of respective coupling elements. In contrast to couplings which transit torque by means of frictional engagement, that is to say, friction couplings, such as, for example, multi-plate clutches or sliding clutches, in positive-locking couplings no retention force is advantageously required in order to maintain the transmission of torque. Furthermore, in positive-locking couplings there is also no slip between the respective coupling elements, by means of which in the coupling position torque can be transmitted or is transmitted.

Preferably, exclusively by means of switching from the decoupling position into the coupling position, the torque-transmitting coupling between the electric drive machine and the drive wheel can be produced. There may thus be provision for no additional couplings for torque transmission to be interposed between the drive wheel and the electric drive machine.

In a further advantageous manner, the electric drive machine in the coupling position may be coupled to the drive wheel by the at least one coupling mechanism without any differential gear mechanism, that is to say, in other words without a differential gear mechanism of the motor vehicle being interposed and consequently in a torque-transmitting manner without any differential gear mechanism.

Preferably, there may be provision for the motor vehicle to comprise a plurality of drive wheels, coupling mechanisms and electric drive machines. Thus, each of the drive wheels may in each case be associated with at least one coupling mechanism and at least one electric drive machine. Therefore, if the motor vehicle has, for example, a four-wheel drive, the motor vehicle may comprise four drive wheels, four electric drive machines and four coupling mechanisms. It is thereby possible, for example, for the respective front drive wheels which are associated with a front section, that is to say, the front of the motor vehicle, to be decoupled by switching the (front) coupling mechanism associated with these front drive wheels and adjusting the decoupling position, whereas the rear drive wheels which are associated with the rear section, that is to say, the rear of the motor vehicle, are coupled by switching the (rear) coupling mechanism and adjusting the coupling position and consequently to be used for driving the motor vehicle. In this exemplary case, the front drive wheels are in a so-called “coasting mode” and are, in contrast to the rear drive wheels, not used for driving the motor vehicle. It is of course also contemplated for the front drive wheels to be used for driving the motor vehicle and for the rear drive wheels to be in coasting mode.

In a particularly preferred manner, the coupling mechanism may be in the form of a gear stage which can be switched between the coupling position and the decoupling position, in particular an intermediate gear stage. This enables a simple integration in a gear mechanism, in particular spur gear mechanism of the motor vehicle. The gear mechanism may preferably be in the form of an automatic gear mechanism.

The invention is based on the general recognition that, as a result of the coupling with precisely one side of the drive axle of the motor vehicle and a single-wheel drive which is brought about thereby, a coupling and decoupling of the drive wheel can be carried out as required. The motor vehicle can be operated in a particularly efficient manner when it comprises a plurality of, for example, four drive wheels which can each be driven with a coupling mechanism and in each case an electric drive machine and as necessary during travel of the motor vehicle, for example, two of the drive wheels can be decoupled by the respective decoupling position of the two coupling mechanisms which are associated with these drive wheels being adjusted. Furthermore, the recognition is based on the fact that the positive-locking coupling can be maintained without application of force in the coupling position and in the decoupling position. In other words—unlike, for example, on friction couplings—no retention force has to be applied in order to maintain the coupling position and consequently the torque transmission or the decoupling position and consequently the interruption of the torque transmission. This also contributes to the increase in efficiency and on the whole enables a low-complexity operation of the coupling mechanism and consequently also of the motor vehicle.

In an advantageous further development of the invention, the coupling mechanism comprises a first gear which is in at least indirect engagement with the drive machine and a second gear which can be coupled by means of the positive-locking coupling to the first gear in a torque-transmitting manner and which is coupled at least indirectly in a rotationally secure manner to the drive wheel. This is advantageous since the coupling mechanism is thereby constructed in a particularly simple and robust manner and consequently has a particularly low susceptibility to failure. The term “indirectly” is generally intended to be understood to mean that additional torque-transmitting elements can be interposed. The respective gear may, for example, be coupled by means of a shaft (as such a torque-transmitting element) and thereby indirectly to the drive machine or the drive wheel. The term “rotationally secure” is generally intended to be understood to mean that a relative rotation is prevented.

In another advantageous further development of the invention, the positive-locking coupling comprises a first coupling element which is coupled at least indirectly to the first gear in a rotationally secure manner and a second coupling element which is coupled at least indirectly to the second gear in a rotationally secure manner. This is advantageous since the positive-locking coupling consequently has a particularly simple and robust structure. The term “indirectly” is intended to be understood to mean that both the respective coupling element and the respective gear can be connected in a rotationally secure manner, for example, to a corresponding shaft, whereby the coupling element can then be connected indirectly to the gear, that is to say, for example, by means of the shaft.

In another advantageous further development of the invention, the positive-locking coupling comprises a connection element which is coupled, on the one hand, at least indirectly to the first gear and, on the other hand, at least indirectly to the first coupling element in a rotationally secure manner. This is advantageous since the connection element enables a particularly simple configuration of the first coupling element. The connection element may be coupled in a reversibly releasable manner, that is to say, in other words in a destruction-free releasable manner, for example, by means of a ridge/groove arrangement, which can also be referred to as a splined tooth arrangement, at least indirectly to the first gear.

In another advantageous further development of the invention, the connection element is in the form of a fixed socket. This is advantageous since the connection element which is in the form of a fixed socket enables a guided movement of the first coupling element in order to switch between the decoupling position and the coupling position. The fixed socket may preferably have an inner tooth arrangement with teeth which extend along a rotation axis of the first gear. This inner tooth arrangement may be in engagement with a complementary tooth arrangement which may be associated with a first shaft which is connected in a rotationally secure manner to the first gear. The connection of the inner tooth arrangement with the complementary tooth arrangement may preferably be in the form of a play-free press fit.

In another advantageous further development of the invention, the positive-locking coupling comprises a locking element. The locking element is constructed to prevent the switching from the decoupling position into the coupling position in the event of a speed difference between the first gear and the second gear. Furthermore, the locking element is constructed to release a relative movement which brings about the switching from the decoupling position into the coupling position between the first coupling element and the second coupling element in the event of speed uniformity between the first gear and the second gear.

In another advantageous further development of the invention, the positive-locking coupling is in the form of a claw coupling. This is advantageous since such a claw coupling is, on the one hand, constructed in a particularly robust and simple manner and, on the other hand, no application of force is required to maintain the coupling position or the decoupling position in each case, but instead only to switch between the coupling position and the decoupling position, that is to say, to switch from the coupling position into the decoupling position and vice versa.

In another advantageous further development of the invention, the coupling mechanism is integrated in a spur gear mechanism of the motor vehicle. This is advantageous since the coupling mechanism can thereby be arranged in a particularly structural-space-saving manner and received in a housing of the spur gear. Preferably, the coupling mechanism may be in the form of an intermediate gear stage of the spur gear mechanism.

A second aspect of the invention relates to a coupling mechanism for a motor vehicle according to the first aspect of the invention. The coupling mechanism can be switched at least between a coupling position, in which the electric drive machine is coupled in a torque-transmitting manner to a drive wheel of the motor vehicle, and a decoupling position, in which the electric drive machine is decoupled from the drive wheel. The at least one coupling mechanism is configured for torque-transmitting coupling to precisely one side of a drive axle of the motor vehicle and comprises a positive-locking coupling for switching between the coupling position and the decoupling position. This coupling mechanism may be operated in a particularly effective manner with little complexity.

A third aspect of the invention relates to a method for operating a motor vehicle having at least one electric drive machine which is constructed to drive the motor vehicle and having at least one coupling mechanism which can be switched at least between a coupling position, in which the electric drive machine is coupled in a torque-transmitting manner to a drive wheel of the motor vehicle, and a decoupling position, in which the electric drive machine is decoupled from the drive wheel. The at least one coupling mechanism is provided for torque-transmitting coupling to precisely one side of a drive axle of the motor vehicle and comprises a positive-locking coupling for switching between the coupling position and the decoupling position. In addition, the coupling mechanism comprises a first gear which is in at least indirect engagement with the drive machine, and a second gear which can be coupled by means of the positive-locking coupling to the first gear in a torque-transmitting manner and which is coupled at least indirectly in a rotationally secure manner to the drive wheel. Furthermore, the positive-locking coupling comprises a first coupling element which is coupled at least indirectly to the first gear in a rotationally secure manner and a second coupling element which is coupled at least indirectly in a rotationally secure manner to the second gear. The positive-locking coupling comprises a locking element which in the method prevents the switching from the decoupling position into the coupling position, whilst the electric drive machine compensates for a speed difference between the first gear and the second gear. With a speed uniformity which is produced using the electric drive machine between the first gear and the second gear, the locking element releases a relative movement, which brings about the switching from the decoupling position into the coupling position, between the first coupling element and the second coupling element. This method enables a particularly efficient and low-complexity operation of the motor vehicle.

If the motor vehicle is in a travel state, in which respective wheels of the motor vehicle which also include the drive wheel rotate, the electric drive machine, at a time prior to a torque-transmitting coupling between the drive wheel and the drive machine via the coupling mechanism in order to accelerate the motor vehicle, can first compensate for the speed difference between the first and the second gear. Only when there is speed uniformity, that is to say, the speed difference between the first gear and the second gear is compensated for, does the locking element release the switching from the decoupling position into the coupling position and consequently the torque-transmitting coupling between the electric drive machine and the drive wheel via the coupling mechanism. The switching from the decoupling position into the coupling position can now be carried out. As soon as the coupling position is adjusted, torque can be transmitted from the electric drive machine to the drive wheel and used to drive or accelerate the motor vehicle.

Furthermore, the transmission of the torque from the electric drive machine to the drive wheel can be rapidly interrupted by switching from the coupling position into the decoupling position. The drive wheel can thereby also be used as a non-driven wheel, which is advantageous, for example, for so-called coasting of the motor vehicle.

The preferred embodiments, which have been set out with respect to one of the aspects, and the advantages thereof apply accordingly to the other aspects of the invention and vice versa.

The features and feature combinations mentioned above in the description and the features and feature combinations mentioned below in the description of the Figures and/or only shown in the Figures can be used not only in the combination set out in each case, but also in other combinations or alone without departing from the scope of the invention.

Other advantages, features and details of the invention will be appreciated from the claims, the following description of preferred embodiments and with reference to the drawings.

The invention is explained once again below with reference to a specific exemplary embodiment.

### BRIEF DESCRIPTION OF THE DRAWINGS

FIG. 1 is a schematic perspective view of a spur gear mechanism which comprises a coupling mechanism and which is coupled to an electric drive machine which is used to drive a drive wheel of a motor vehicle (illustrated in a highly abstracted manner); and

FIG. 2 is a schematic sectioned illustration of the coupling mechanism which is illustrated in half-section.

### DETAILED DESCRIPTION OF THE DRAWINGS

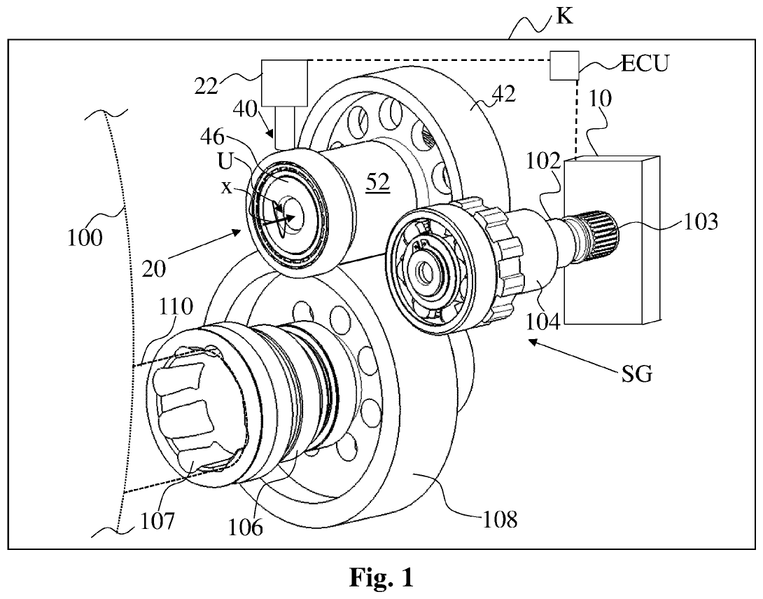

FIG. 1 shows a schematic perspective view of a motor vehicle K which comprises a total of four electric drive machines 10, four spur gear mechanisms SG with four coupling mechanisms 20 and four drive wheels 100. In each case, one of the coupling mechanisms 20 is associated with each of the spur gear mechanisms SG. In other words, one of the coupling mechanisms 20 is integrated in each case in one of the spur gear mechanisms SG of the motor vehicle K.

Each of the drive machines 10 is coupled to one of the spur gear mechanisms SG in each case. Each of the spur gear mechanisms SG can further be coupled to one of the drive wheels 100 by the respective coupling mechanism 20 of the respective spur gear mechanism SG being switched from a decoupling position ES into a coupling position KS. In the coupling position KS, the respective drive wheel 100 is coupled to the respective drive machine 10 in a torque-transmitting manner, whereas the torque transmission between the drive wheel 100 and drive machine 10 is interrupted in the decoupling position ES. In other words, the respective electric drive machine 10 in the decoupling position ES of the respective coupling mechanism 20 is decoupled from the drive wheel 100. On the whole, a selective driving of the respective drive wheels 100, consequently a single-wheel drive of each of the drive wheels 100, is thereby enabled. In other words, each of the drive wheels 100 can be driven by the electric drive machine 10 which is associated in each case therewith independently of the other drive wheels 100.

For reasons of clarity, in FIG. 1 only one of the drive machines 10, only one of the spur gear mechanisms SG with one of the coupling mechanisms 20 and only one of the drive wheels 100 is illustrated. However, the following statements relating to the drive machine 10, the spur gear mechanism SG, the coupling mechanism 20 and the drive wheel 100 apply to all the drive machines 10, spur gear mechanisms SG, coupling mechanisms 20 and drive wheels 100 of the motor vehicle K.

The spur gear mechanism SG comprises a first gear shaft 102 which is coupled in a torque-transmitting manner to the electric drive machine 10 of the motor vehicle K. The torque-transmitting and consequently rotationally secure coupling between the first gear shaft 102 and the drive machine 10 is carried out in this instance only by way of example via a spline shaft end portion 103, that is to say, in other words an end portion of the first gear shaft 102 which has a splined tooth arrangement. Via this splined tooth arrangement, the first gear shaft 102 is in at least indirect engagement with the electric drive machine 10. A first gear wheel 104 is also coupled in a rotationally secure manner to the first gear shaft 102. The first gear wheel 104 is in engagement with a first gear 42 of the coupling mechanism 20. Consequently, the first gear 42 of the coupling mechanism 20 is in indirect engagement with the drive machine 10, that is to say, is coupled indirectly to the drive machine 10.

The spur gear mechanism SG further comprises a second gear shaft 106 which is coupled to the drive wheel 100 in a torque-transmitting manner. The first gear shaft 104 is used for drive-side torque transmission and the second gear shaft 106 is used for output-side torque transmission. The torque-transmitting and consequently rotationally secure coupling between the second gear shaft 106 and the drive wheel 100 is carried out in this instance purely by way of example via an inner splined tooth arrangement 107 of the second gear shaft 106. The drive wheel 100 is in engagement with the inner splined tooth arrangement 107 via a drive axle 110 which is illustrated with dashed lines in FIG. 1 and is thereby coupled to the second gear shaft 106 of the spur gear mechanism SG in a rotationally secure manner. With reference to FIG. 1, it can be seen that the coupling mechanism 20 is provided for torque-transmitting coupling to precisely one side of the drive axle 110 of the motor vehicle K, whereby a single-wheel drive of the drive wheel 100 can be carried out. In this instance, the transmission of the torque between the electric drive machine 10 and the drive wheel 100 can be carried out without a differential gear mechanism being interposed. The transmission of the torque between the electric drive machine 10 and the drive wheel 100 can thus be carried out in a manner free from a differential gear mechanism (without a differential gear mechanism).

A second gear wheel 108 of the spur gear mechanism SG is also coupled to the second gear shaft 106 in a rotationally secure manner. The second gear wheel 108 is in engagement with a second gear 52 of the coupling mechanism 20. Consequently, the second gear 52 of the coupling mechanism 20 is at least indirectly coupled to the drive wheel 100 in a rotationally secure manner.

For reasons of clarity, respective teeth of the (first and second) gear wheels 104, 108 and the (first and second) gears 42, 52 are not illustrated in FIG. 1.

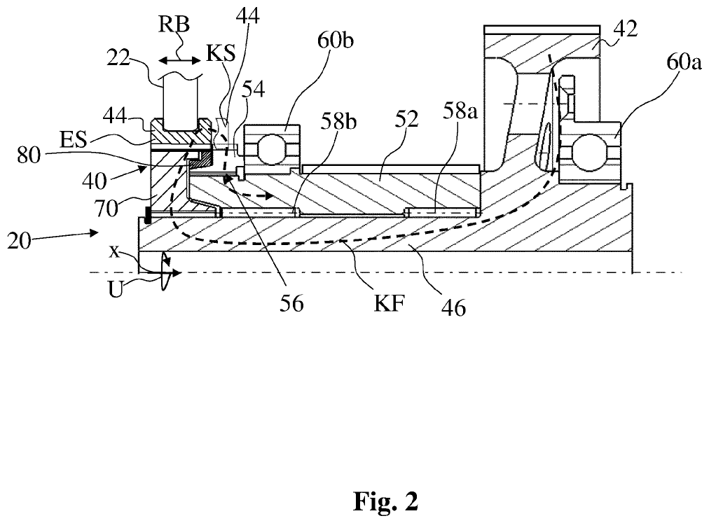

FIG. 2 shows the coupling mechanism 20 in an enlarged sectioned view and in half-section.

With reference to FIG. 2, it can be seen that the coupling mechanism 20 comprises a positive-locking coupling 40 which is in the form of a claw coupling for switching between the coupling position KS and the decoupling position ES. In addition, FIG. 2 shows that the first gear 42 is connected integrally to a shaft 46. When the torque is transmitted from the electric drive machine 10 to the drive wheel 100, that is to say, when the drive wheel 100 is driven, the first gear wheel 42 rotates and consequently the shaft 46 rotates in a circumferential direction U about a rotation axis x which at the same time constitutes a center axis of the shaft 46 and the first gear 42.

The first gear 42 can be coupled in a torque-transmitting manner by means of the positive-locking coupling 40 to the second gear 52 by the positive-locking coupling 40 and consequently the coupling mechanism 20 being switched between the coupling position KS and the decoupling position ES.

The positive-locking coupling 40 comprises a first coupling element 44 which is coupled to a connection element 70. The first coupling element 44 is bidirectional and can be displaced relative to the connection element 70 according to a relative movement RB which is indicated with a double-headed arrow parallel with the rotation axis x and consequently in translation. In order to enable the translational displaceability of the first coupling element 44, the first coupling element 44 and the connection element 70 each have tooth arrangements which are in engagement with each other, in particular splined tooth arrangements. The first coupling element 44 and the connection element 70 thereby remain in engagement during the relative movement RB.

The first coupling element 44 is coupled indirectly, that is to say, via the connection element 70 and the shaft 46, in a rotationally secure manner to the first gear 42. A second coupling element 54 of the coupling mechanism 20 is coupled in a rotationally secure (and consequently torque-transmitting) manner to the second gear 52 in a common coupling region 56. In this coupling region 56, for example, respective splined tooth arrangements of the second coupling element 54 and the second gear 52 may engage in each other.

In the present embodiment, the connection element 70 is in the form of a fixed socket.

The second gear 52 is rotatably supported on the shaft 46 by means of respective needle bearings 58a, 58b, as can also be seen in FIG. 2. With respect to respective roller bearings 60a, 60b which may, for example, be in the form of ball bearings, the coupling mechanism 20 is supported and consequently mounted on a housing (which is not shown in greater detail in this instance) of the spur gear mechanism SG. Via the roller bearing 60a, the first gear 42 or the shaft 46 is at least indirectly supported on the housing, whereas the second gear 52 is supported via the additional roller bearing 60b at least indirectly on the housing.

As a result of the relative movement RB of the first coupling element 44, the coupling mechanism 20 can be switched selectively into the decoupling position ES, in which the electric drive machine 10 is decoupled from the drive wheel 100, or into the coupling position KS, in which the first gear 42 is coupled in a torque-transmitting manner to the second gear 52 and consequently overall the electric drive machine 10 is coupled to the drive wheel 100.

In the coupling position KS, a force path KF, which is illustrated in FIG. 2 by way of example by means of an arrow, is produced between the first gear 42 and the second gear 52.

For reasons of clarity, the first coupling element 44, which can also be referred to as a first claw element, is illustrated in the coupling position KS only partially and in a dotted manner, but it can be seen that the first coupling element 44 in the coupling position KS is in engagement with the second coupling element 54 which can also be referred to as a second claw element, that is to say, is coupled in a torque-transmitting manner. In the decoupling position ES, the first coupling element 44 and the second coupling element 54 are in contrast separated from each other, that is to say, decoupled, so that the force path KF between the first coupling element 44 and the second coupling element 54 is interrupted and accordingly no torque transmission can also take place between these coupling elements 44, 54.

In order to adjust the coupling position KS or the decoupling position ES, the coupling mechanism 20 comprises a switching apparatus 22 which is illustrated schematically in FIG. 1 and as a cut-out in FIG. 2. The switching apparatus 22 can apply a switching force to the first coupling element 44 in order to switch the coupling element back and forth in accordance with the relative movement RB between the coupling position KS and the decoupling position ES. The switching device 22 can be controlled by means of a control device ECU. The control device ECU may be associated with the motor vehicle K, the spur gear mechanism SG or, for example, the coupling mechanism 20. In this instance, using the control device ECU, the electric drive machine 10 can also be controlled.

In order to prevent the switching from the decoupling position ES into the coupling position KS in the event of a speed difference between the first gear 42 and the second gear 52, the positive-locking coupling 40 comprises a locking element 80. As soon as the speed difference is reduced to the value “0” and there is consequently speed uniformity between the first gear 42 and the second gear 52, the locking element 80 releases the relative movement RB which brings about the switching from the decoupling position ES into the coupling position KS between the first coupling element 44 and the second coupling element 54. The speed difference can be compensated for by the electric drive machine 10. Additionally or alternatively, the speed difference may also be compensated for by the locking element 80 so that the locking element 80 can be used for synchronization. The locking element 80 can generally perform the function of a synchronization ring and/or be in the form of a synchronization ring. In this instance, the locking element 80 supports the electric drive machine which can also be referred to as an electric motor, or E motor for short, during the synchronization. In order to compensate for the speed difference, the electric drive machine 10 during travel operation of the motor vehicle K at least substantially adapts the speed of the first gear 42 to the speed of the second gear 52.

The coupling mechanism 20 enables a particularly efficient operation of the motor vehicle K since the coupling mechanism 20 enables a coupling and decoupling between the electric drive machine 20 and the drive wheel 100 as required, particularly when the motor vehicle K comprises the plurality of electric drive machines 20, coupling mechanisms 20 (or spur gear mechanisms SG each having a coupling mechanism 20) and drive wheels 100 which can be coupled and decoupled in each case independently of each other.

Whilst, for example, with conventional multi-plate couplings, corresponding retention forces are required in order to maintain a coupled state and a linked torque transmission, this is not necessary in the present coupling mechanism 20 as a result of the positive-locking coupling 40. In contrast to a multi-plate coupling, the present positive-locking coupling 40 can maintain the coupling position KS or the decoupling position ES in a force-free manner. Thus, after completed relative movement RB and after the coupling position KS or the decoupling position ES has been adjusted, no additional retention force which has to be applied, for example, by the switching apparatus 22, is required in order to prevent an undesirable movement of the first coupling element 44 parallel with the rotation axis x.

The locking element 80 and/or the electric drive machine 10 enable in summary a particularly rapid reduction of the speed difference between the first gear 42 and the second gear 52 during operation of the motor vehicle K and consequently a particularly rapid adjustment of the speed uniformity between these gears 42, 52. Particularly low switching times for switching between the coupling position KS and the decoupling position ES can thereby be produced, wherein any perceptible jerking or undesirable acoustic feedback during the switching can at least be damped or even eliminated.

In summary, the motor vehicle K with the coupling mechanism 20 enables the synchronization between the first gear 42 and the second gear 52, that is to say, the drive-side and output-side synchronization, wherein at the same time at least substantially loss-free maintenance of the coupling position KS and decoupling position ES is enabled.

### LIST OF REFERENCE NUMERALS

10 Electric drive machine
20 Coupling mechanism
22 Switching apparatus
40 Positive-locking (form-fit) coupling
42 First gear
44 First coupling element
46 Shaft
52 Second gear
54 Second coupling element
56 Coupling region
58a,b Needle bearing
60a,b Roller bearing
70 Connection element
80 Locking element
100 Drive wheel
102 First gear shaft
103 Spline shaft end portion
104 First gear wheel
106 Second gear wheel
107 Inner splined tooth arrangement
108 Second gear wheel
110 Drive axle
ECU Control device
K Motor vehicle
KF Force path
KS Coupling position
ES Decoupling position
RB Relative movement
SG Spur gear mechanism
U Circumferential direction
x Rotation axis

1.-10. (canceled)

11. A motor vehicle, comprising:
at least one electric drive machine for driving the motor vehicle;
at least one coupling mechanism which is switchable at least between a coupling position, in which the electric drive machine is coupled in a torque-transmitting manner to a drive wheel of the motor vehicle, and a decoupling position, in which the electric drive machine is decoupled from the drive wheel, wherein
the at least one coupling mechanism is configured for torque-transmitting coupling to precisely one side of a drive axle of the motor vehicle and comprises a positive-locking coupling for switching between the coupling position and the decoupling position.

12. The motor vehicle according to claim 11, wherein the coupling mechanism comprises:
a first gear which is in at least indirect engagement with the drive machine; and
a second gear which is couplable by the positive-locking coupling to the first gear in a torque-transmitting manner and which is coupled, at least indirectly, in a rotationally secure manner to the drive wheel.

13. The motor vehicle according to claim 12, wherein the positive-locking coupling comprises:
a first coupling element which is coupled at least indirectly to the first gear in a rotationally secure manner; and
a second coupling element which is coupled at least indirectly to the second gear in a rotationally secure manner.

14. The motor vehicle according to claim 13, wherein the positive-locking coupling further comprises:
a connection element which is coupled, on the one hand, at least indirectly to the first gear and, on the other hand, at least indirectly to the first coupling element in a rotationally secure manner.

15. The motor vehicle according to claim 14, wherein the connection element is in a form of a fixed socket.

16. The motor vehicle according to claim 15, wherein the positive-locking coupling further comprises:
a locking element for preventing the switching from the decoupling position into the coupling position in an event of a speed difference between the first gear and the second gear and for releasing a relative movement which brings about the switching from the decoupling position into the coupling position between the first coupling element and the second coupling element in an event of speed uniformity between the first gear and the second gear.

17. The motor vehicle according to claim 13, wherein the positive-locking coupling further comprises:
a locking element for preventing the switching from the decoupling position into the coupling position in an event of a speed difference between the first gear and the second gear and for releasing a relative movement which brings about the switching from the decoupling position into the coupling position between the first coupling element and the second coupling element in an event of speed uniformity between the first gear and the second gear.

18. The motor vehicle according to claim 11, wherein
the positive-locking coupling is a claw coupling.

19. The motor vehicle according to claim 11, wherein
the coupling mechanism is integrated in a spur gear mechanism of the motor vehicle.

20. A coupling mechanism for a motor vehicle having an electric drive machine for driving the motor vehicle, wherein
the coupling mechanism is switchable at least between a coupling position, in which the electric drive machine is coupled in a torque-transmitting manner to a drive wheel of the motor vehicle, and a decoupling position, in which the electric drive machine is decoupled from the drive wheel, and
the coupling mechanism is configured for torque-transmitting coupling to precisely one side of a drive axle of the motor vehicle and comprises a positive-locking coupling for switching between the coupling position and the decoupling position.

21. A method for operating a motor vehicle having an electric drive machine for driving the motor vehicle and a coupling mechanism switchable at least between a coupling position, in which the electric drive machine is coupled in a torque-transmitting manner to a drive wheel of the motor vehicle, and a decoupling position, in which the electric drive machine is decoupled from the drive wheel, wherein the coupling mechanism is configured for torque-transmitting coupling to precisely one side of a drive axle of the motor vehicle and comprises a positive-locking coupling for switching between the coupling position and the decoupling position, the method comprising:
preventing, via a locking element of the positive-locking coupling, a switching from the decoupling position into the coupling position, whilst the electric drive machine compensates for a speed difference between a first gear and a second gear of the coupling mechanism; and
releasing, via the locking element, a relative movement which brings about the switching from the decoupling position into the coupling position between a first coupling element and a second coupling element of the positive-locking coupling in an event of speed uniformity between the first gear and the second gear.
